(19) United States
(12) Patent Application Publication
(10) Pub. No.: US 2012/0012770 A1
(43) Pub. Date: Jan. 19, 2012

(54) Ball Valve

(75) Inventor: Angelo Bugatti, Castegnato (IT)

(73) Assignee: VALVOSANITARIA BUGATTI S.P.A., Castegnato (IT)

(21) Appl. No.: 12/836,672

(22) Filed: Jul. 15, 2010

(51) Int. Cl. F16K 5/08

(52) U.S. Cl. 251/315.1; 251/315.01

(57) ABSTRACT

The present invention relates to a ball plug for taps or valves for controlling the flow of a fluid, comprising at least one main passage (15) adapted for placing inlet and outlet ducts in communication, and at least two secondary holes or passages (19, 20) adapted for placing the main passage (15) in fluid communication with the plug seat (13) in the valve body so that part of the inlet fluid is sucked towards the outlet duct passing through said seat.

### FIELD OF THE INVENTION

The present invention relates to valves or taps for the control of a fluid flow, in particular a liquid and more in particular, water, and it mainly refers to a ball plug for said valves with the function of washing the swat wherein it is inserted.

### BACKGROUND ART

As known, ball valves comprise a body wherein there are obtained at least one fluid inlet duct and at least one fluid outlet duct, and a ball plug located into a respective seat obtained in the body, between said ducts, and capable of rotating around an axis so as to intercept the fluid flow and adjust its rate. The ball plug is centrally crossed by a passage which, based on the angular position of the plug, can be totally aligned with the fluid inlet and outlet ducts to obtain the maximum rate, partly aligned for smaller rates or not aligned with said ducts to close the valve. For its axial movements, the ball plug is fitted on a control shaft which can be actuated, for example, by a lever.

Between each fluid inlet and outlet duct and the ball plug there is provided at least one annular seal that prevents fluid leaks from the valve when the plug is turned in closed position.

However, when the plug shifts from a position of at least partial opening of the valve to the closed position, a certain amount of fluid remains trapped in the plug passage and thereby in its seat. The trapped fluid becomes stagnant inside the valve body until a further opening of the valve allows it to flow out through the outlet duct.

In particular when a ball valve is used for controlling the flow of drinking water, water should not become stagnant into the valve body when the valve is not closed, so that the user may receive clean and drinkable water as soon as the valve is opened again.

### SUMMARY OF THE INVENTION

Object of the present invention is that of proposing a ball valve which meets such requirement, that is, which allows avoiding the stagnation of a fluid, in particular water, into the valve body when the valve is closed.

Such object is achieved by inserting a ball plug into the valve body which, besides being crossed by a main passage adapted for placing the valve inlet and outlet duct into communication, is crossed by at least two secondary passages suitably connecting the main passage with the plug seat.

The flow of the fluid under pressure through the ball plug therefore creates a suction pressure into the seat, so that the fluid contained therein is continuously sucked towards the outlet duct. This suction action of the fluid from the plug seat therefore allows a continuous circulation of the fluid present therein and thereby a continuous wash. Moreover, immediately before the valve is closed, the plug seat is emptied of the fluid, thereby preventing its stagnation into the valve body.

### BRIEF DESCRIPTION OF THE DRAWINGS

An example of embodiment of the invention is described hereinafter more in detail, with reference to the attached indicative and non-limiting drawings, wherein:

FIG. 1 shows a perspective see-through view of a ball valve wherein there is inserted and illustrated in partial section a ball plug according to the invention;

FIG. 2 shows an axial section view of the ball valve of FIG. 1; and

FIGS. 3 and 4 show axial section views of two further different embodiments of the ball valve.

FIG. 5 shows an apparatus for blocking ball plugs for their perforation.

### DETAILED DESCRIPTION OF THE INVENTION

In said drawings, reference numeral 10 denotes the body of a tap or ball valve for controlling the flow of a fluid, for example water, going into said body 10 through an inlet duct 11 and coming out of it through an outlet duct 12. The inlet/outlet indication of said ducts is given with reference to a direction of the fluid flow having a direction indicated in the drawings with arrow F. However, as in the example shown, the two ducts 11 and 12 can also be equal and therefore be used as inlet or outlet without distinction.

A seat 13 is obtained between ducts 11 and 12 wherein there is housed a ball plug 14 capable of rotating around an axis X so as to intercept the fluid flow and adjust its rate. The ball plug is axially crossed by a main passage 15 which, based on the angular position of the plug, can be totally aligned with the fluid inlet and outlet ducts 11, 12 (fully open valve), inclined relative to said ducts (partly open valve) or orientated orthogonally to them (fully closed valve). For its axial movements, the ball plug 14 is fitted on a control shaft 16 which can be actuated by a lever 17.

Moreover, at least two annular seals 18 are provided into body 10, which delimit seat 13 of plug 14 and interact with it to prevent fluid leaks from the valve when the plug is turned in closed position.

According to the invention, moreover, at least two secondary holes or passages 19, 20 are obtained in plug 14, adapted for placing the main passage 15 in fluid communication with seat 13 of the plug.

According to a preferred embodiment of the invention, said secondary holes or passages 19, 20 are inclined relative to the plug rotation axis X. In particular, always considering the direction F of the fluid flowing through the valve, one of the passages (19) converges towards the fluid flow, whereas the other (20) diverges from it. In this way, upon the passage of the fluid flow in the direction F, a suction pressure will generate into the converging hole or passage 19; if the fluid has an opposed direction, the suction pressure will generate in the hole or passage 20.

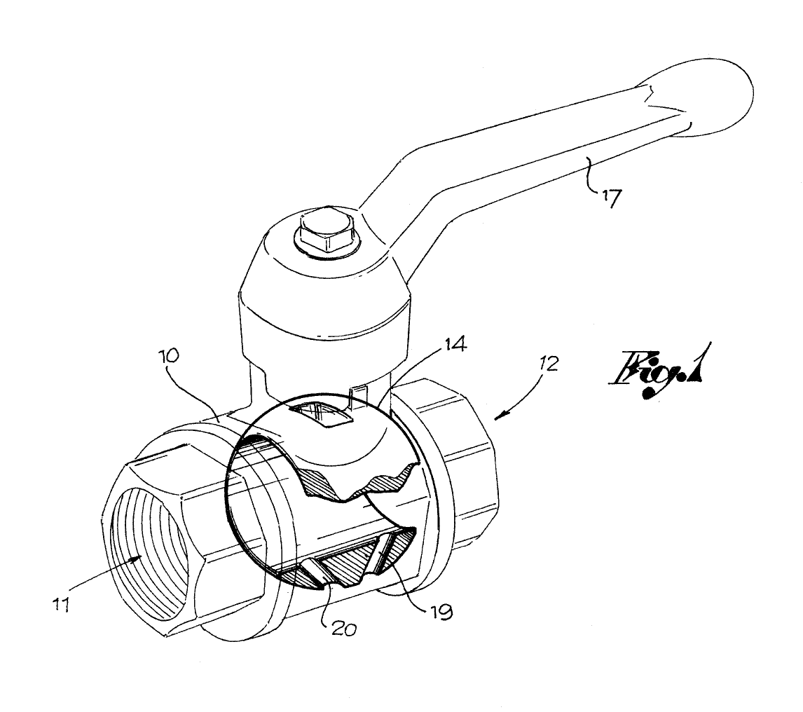

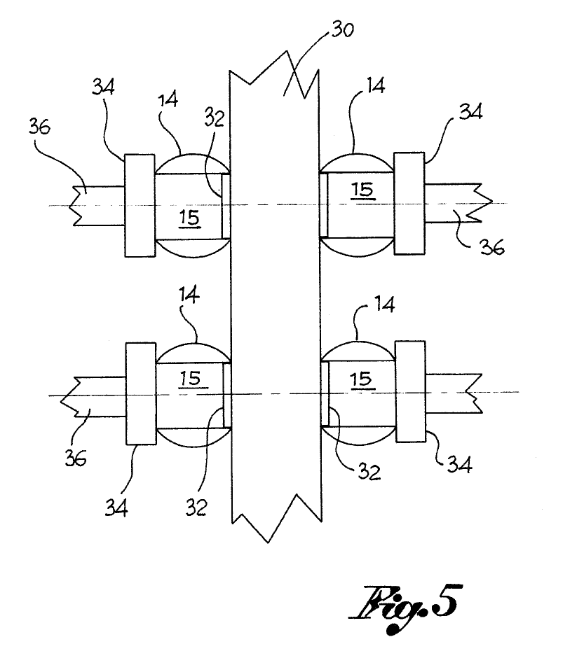

The two secondary holes or passages 19, 20 can be obtained in the same side as plug 14 relative to the main passage 15, as shown in FIGS. 1, 2 and 3, or at sides opposed to it, as shown in FIG. 4.

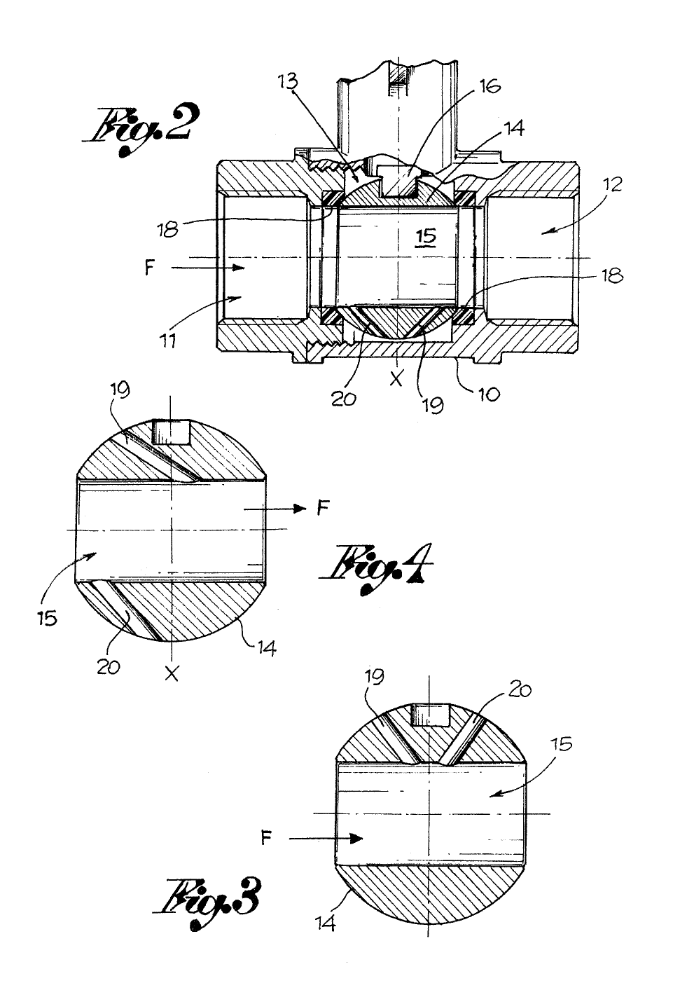

Moreover, according to a preferred embodiment of the invention shown in FIGS. 1 and 2, the main passage 15 of the ball plug 14 exhibits a constant fluid flow section, and the secondary passages 19, 20 are substantially obtained so as to connect the ends of the main passage 15 to the central portion of the plug seat 13.

Advantageously, the inclination of the secondary passages 19, 20 relative to the fluid flow direction is selected by 30° hexagesimal.

In any case, the suction pressure generated in a secondary passage 19 or 20 by the passage of the fluid through the ball plug makes a part of the fluid be constantly sucked through the other secondary passage into seat 13, and hence into the main passage 15 again and in the outlet duct 12. Therefore, the fluid can never become stagnant into seat 13, but it is continuously recirculated with the result of keeping the seat itself clean.

Moreover, immediately before the valve is closed, seat 13 is emptied of the fluid, thereby preventing it from becoming stagnant therein up to the next valve opening.

Advantageously, the plug according to the invention also has an important anti-freeze function. Thanks to the secondary passages any frozen liquid present in the ball seat can pour out into the main ball passage, thereby preventing breakage of the valve body.

The realisation of secondary passages 19, 20 of the required quality and precision requires perfect blocking of the ball 14. In fact the perforation operation permitting the creation of the secondary passages is extremely delicate in that the perforation is oblique to the main axis of the ball. At the same time, such blocking of the ball must not entail the risk of dents or damage to the ball itself.

FIG. 5 shows an example of a blocking apparatus of four balls 14 for the realisation of the secondary passages 19, 20.

Such apparatus comprises a central shoulder 30, for example made from steel, on which a central embossment 32 is made or attached, for each ball, suitable for coupling with the main passage 15 of the ball 14. In other words, a ball plug 14 is positioned against the shoulder 30 centring it on a central embossment 32. Preferably, this central embossment 32 is of limited thickness, so as not to occupy the portions of the main passage which the secondary passages 19, 20 to be made, open onto, thereby not obstructing the perforation procedure.

Each ball plug 14 is then firmly blocked against the central shoulder 30 by a pusher 34 which acts on the ball 14 from the side opposite the shoulder 30. Said pusher 34 is supported by a relative pusher holder pin 36, for example made of steel. Advantageously, rather, the pusher 34 is made from plastic material, so as not to damage the ball plug while it is pressed against the shoulder by the pusher.

The ball plug thus blocked can then be subjected to the perforation process for realisation of the secondary passages 19, 20. It should be emphasized that such blocking apparatus protects the ball plug from any damage (dents, damage of the edges etc.) which might compromise functioning of the ball valve.

What is claimed is:

1. Ball valve for controlling the flow of a fluid, comprising a ball plug located with possibility of axial rotation inside a seat obtained in the body of said valve, between at least one fluid inlet duct and at least one fluid outlet duct, wherein said ball plug comprises at least one main passage, adapted for placing said inlet and outlet ducts in communication, and at least two secondary holes or passages adapted for placing the main passage in fluid communication with the seat in the valve body so that part of the inlet fluid is sucked towards the outlet duct passing through said seat.

2. Ball valve according to claim 1, wherein said secondary holes or passages are inclined relative to the direction of the fluid flow circulating into the main passage.

3. Ball valve according to claim 2, wherein the secondary passages are substantially obtained so as to connect the ends of the main passage to the central portion of the plug seat.

4. Ball valve according to claim 1, wherein said secondary holes or passages are obtained into the plug body at opposed sides relative to the main passage.

5. Ball valve according to claim 1, wherein said secondary holes or passages are obtained into the plug body at the same side as the main passage.

6. Ball valve according to claim 1, wherein considering a direction F for the fluid flow direction, one of the secondary holes or passages is diverging from said direction whereas the other is converging.

7. Ball valve according to claim 6, wherein the inclination of the secondary passages relative to the fluid flow direction is of about 30° hexagesimal.

8. Ball valve according to claim 1, wherein the main passage exhibits a constant fluid passage section.

9. Apparatus for blocking at least one ball valve plug crossed by a main axial passage, comprising a central shoulder on which at least one central embossment is made suitable for coupling to the main passage of the ball, a pusher suitable for acting on said plug on the side opposite the shoulder, and a pusher holder pin suitable for supporting the pusher, wherein the pusher is made in plastic material.
